(19) United States
(12) Patent Application Publication
(10) Pub. No.: US 2011/0167965 A1
(43) Pub. Date: Jul. 14, 2011

(54) NON-SLIP AND ANTI-BURRING GAS CYLINDER SPANNER

(76) Inventor: Michael FIELDING, Palmerston North (NZ)

(21) Appl. No.: 12/686,154

(22) Filed: Jan. 12, 2010

(51) Int. Cl. B25B 13/48; B25B 13/04

(52) U.S. Cl. 81/124.2; 81/124.3

(57) ABSTRACT

A non-slip and anti-burring gas cylinder spanner for tightening and loosening hose coupling nuts used with gas cylinder valves includes a body with a handle extending opposite a head. A nut engaging portion within the head defines an internal aperture having at least five nut engaging sides dimensioned and configured to engage corresponding sides of a hexagonal nut so the sides of the nut engaging element have increased contact points with the sides of the nut, preventing slippage and burring. A backing plate attached to the head is positioned over a part of the nut engaging element so the backing plate indicates correct spanner/nut positioning and prevents slippage of the spanner relative to the nut when tightening or loosening. The nut engaging element and the backing plate combination prevents rotational and side slippage of the spanner relative to the nut and burring of the nut when tightening and loosening.

### FIELD OF INVENTION

The invention relates to a non-slip and anti-burring spanner, typically for tightening and un-tightening hose coupling nuts used with gas cylinder valves.

### BACKGROUND OF INVENTION

The coupling of hoses to gas cylinder valves require to be safely and securely connected in order to prevent gas leakage which can not just be an expensive waste but very hazardous especially for gas cylinders containing flammable and poisonous gases.

Gas cylinders are designed with safety in mind as the gases in side the cylinder a generally highly pressurised and in some cases the gases are flammable and/or hazardous chemical gases. The gas cylinders have a securely mounted valve to which a hose is connectable thereto by a hose coupling usually involving a hexagonal nut arrangement whereby the tightening of the nut securely fastens the hoes coupling to the valve in a air/gas tight manner.

However this hose coupling arrangement can and is the weakest part associated with the use of gas cylinders. This is because when a gas cylinder needs to be replaced the used gas bottle is disconnected from the hose and a replacement gas bottle connected. The tightening of the nut too severely can lessen the integrity of the hose coupling, thus allowing gas leakage which may have catastrophic effects. Similarly not tightening the nut enough can also cause leakage.

A spanner is typically used to couple and uncouple a hose to a gas cylinder, however the spanner over time or with incorrect use can slip relative to the nut on the hose coupling and/or the spanner will cause the nut to burr. The slipping of the spanner and the burring of the nut can and would ultimately lead to the nut not being tightened correctly.

The burring of the nut on the gas cylinder hose coupling is not just an unwanted and expensive inconvenience in having to replace the nut and/or hose coupling, but also can lead to a waste of gas through leakage and in some instance can lead to catastrophic results especially if the gas is flammable or is a hazardous chemical gas.

### OBJECT OF THE INVENTION

It is an object of the invention to provide a non-slip and anti-burring spanner, typically for tightening and un-tightening hose coupling nuts used with gas cylinder valves that ameliorates some of the disadvantages and limitations of the known art or at least provide the public with a useful choice.

### SUMMARY OF INVENTION

In a first aspect the invention resides a non-slip and anti-burring spanner, typically for tightening and un-tightening hose coupling nuts used with gas cylinder valves, said spanner includes:
(i) a body with a handle extending in one direction and a head extending in the opposite direction;
(ii) a nut engaging means positioned within the head, the nut engaging means has at least five nut engaging sides dimensioned and configured to snugly engage and co-operate with corresponding sides of a hexagonal nut used with gas cylinder hose couplings such that the sides of the nut engaging means have increased contact points with the sides of the nut in order to prevent slippage and burring; and
(iii) a backing plate attached to one side of the head and positioned over a part of the nut engaging means such that the backing plate is adapted to indicate the correct positioning of the spanner on the nut and to prevent side ways slippage of the spanner relative to said nut when tightening or un-tightening the nut;
   wherein, when in use, the combined effect of the nut engaging means and the backing plate is such that rotational and side slippage of the spanner relative to the nut is prevented and burring of the nut is prevented when tightening and un-tightening of the nut.

Preferably, the nut engaging means has six nut engaging sides.

Preferably, the nut engaging means defines an internal aperture that is adapted to accommodate the hexagonal nut therein such that the sides of the nut engaging means are in non slippage contact with the corresponding sides of the hexagonal nut.

Preferably, the internal aperture is open to both sides of the head.

Preferably, the backing plate is positioned on the head such that the backing plate at least partially covers one of the openings of the aperture defined by the nut engaging means,

Preferably, the backing plate has an aperture dimensioned less than the dimensions of the aperture of the nut engaging means but greater than the circumferential dimensions of a hose connected to the hose coupling of the gas cylinder such that the spanner is adapted to be retained on the hose when not in use and when in use adapted to be slid along the hose to the nut so as to allow tightening or un-tightening the nut.

Preferably, the head of the spanner includes a side edge opening that extends from the distal side edge of the head to the internal aperture of the nut engaging means to allow access to the internal aperture, wherein the width of the opening is dimensioned to be of a size that is only slightly greater than the width of a hose connected to the hose coupling of the gas cylinder such that the spanner is adapted when in use to be positioned, via the side edge opening, on to the hose and then slid along the hose, via the internal aperture, to the nut so as to allow tightening or un-tightening the nut and when not in use be removed therefrom.

Preferably, the backing plate has an aperture dimensioned less than the dimensions of the aperture of the nut engaging means but greater than the circumferential dimensions of a hose connected to the hose coupling of the gas cylinder and has an opening of the same dimensions as the side edge opening of the head such that the spanner is adapted when in use to be positioned, via the head side edge opening and the backing plate opening, on to the hose and then slid along the hose, via the internal aperture, to the nut so as to allow tightening or un-tightening the nut and when not in use be removed therefrom.

Preferably, the longitudinal axis of the side edge opening is co-axially aligned with the longitudinal axis of the spanner such that the mouth of the opening extends outward and in a opposite direction to the handle.

Preferably, the spanner includes a hollow insert that is adapted to fit within the aperture defined by the nut engaging means, the internal walls of the insert are dimensioned and configured to have at least five sides and are adapted to cooperate with the hexagonal sides of the nut, wherein the insert is adapted to allow for nuts of reduced size.

Preferably, the spanner includes a series of inserts each of varying reduced dimensions to allow the spanner to be used with nuts of different sizes.

Preferably, the each insert defines an internal aperture that, in use, accommodates the hexagonal nut therein such that the sides of the nut engaging means are in contact with the corresponding sides of the hexagonal nut.

Preferably the insert has two open ends, one of which is covered with a backing plate that has an aperture dimensioned less than the dimensions of the inserts aperture, but greater than the circumferential dimensions of the hose.

Preferably, each insert includes a side edge opening that cooperates and aligns with the corresponding side edge opening in the head of the spanner and includes a similar dimensioned positioned opening in the backing plate, such that the spanner is adapted when in use to be positioned, via the respective side edge openings and the backing plate opening, on to the hose and then slid along the hose, via the internal aperture, to the nut so as to allow tightening or un-tightening the nut and when not in use be removed therefrom.

In other aspects herein described

### BRIEF DESCRIPTION

The invention will now be described, by way of example only, by reference to the accompanying drawings:

FIG. 1 shows an illustrative view of the non-slip and anti-burring spanner in use with a hose coupling with a gas cylinder in accordance to a preferred first embodiment of the invention.

FIG. 2 shows perspective view of non-slip and anti-burring spanner in accordance to a first embodiment of the invention.

FIG. 3 shows a close view of the head portion of the non-slip and anti-burring spanner shown in FIG. 2.

FIG. 4 shows an insert for use with non-slip and anti-burring spanner in accordance to a second embodiment of the invention.

FIG. 5 shows a perspective view of non-slip and anti-burring spanner with an insert as shown in FIG. 4.

FIG. 6 shows a side view of a non-slip and anti-burring spanner in accordance to a third embodiment of the invention.

FIG. 7 shows a side view of a non-slip and anti-burring spanner in accordance to a fourth embodiment of the invention.

### DESCRIPTION OF DRAWINGS

The following description will describe the invention in relation to preferred embodiments of the invention, namely a non-slip and anti-burring spanner, typically for tightening and un-tightening hose coupling nuts used with gas cylinder valves. The invention is in no way limited to these preferred embodiments as they are purely to exemplify the invention only and that possible variations and modifications would be readily apparent without departing from the scope of the invention.

FIG. 1 shows a non-slip and anti-burring spanner 10 in use with a typical gas cylinder 1. The gas cylinder 1 has a valve 2 mounted thereto a hose 3 connected to the valve 2 by a hose coupling arrangement that includes a hexagonal valve (not shown). The spanner 10 is shown in a tightening position on the nut where the internal face of the backing plate 30 of the spanner abuts a side face of the nut.

FIGS. 2 and 3 show the spanner 10 in full detail. The spanner 10 has a body with a handle 11 extending in one direction and a head 12 extending in the opposite direction. The head 12 of the spanner 10 has a nut engaging portion 13 having six sides 21, 22, 23, 24, 25, 26. The nut engaging portion 12 defines an internal aperture 13 in which the nut can be accommodated. The internal aperture is open to both sides of the spanner 10. The sides 21, 22, 23, 24, 25, 26 of the nut engaging portion 13 are dimensioned and configured to snugly engage and co-operate with corresponding sides of a hexagonal nut of a typically gas cylinder hose coupling, such that the sides 21, 22, 23, 24, 25, 26 have an increased contact points with the sides of the nut in order to prevent slippage and burring of the nut. Even though six sides are shown it is envisaged that the nut engaging portion could have at least five sides.

A backing plate 30 is attached to one side of the head 12 and is positioned over one of the openings of the internal aperture of the nut engaging portion 13 such that the backing plate 30 assists in the correct positioning of the spanner 10 on the nut and also to prevent side ways slippage of the spanner 10 relative to said nut when tightening or un-tightening the nut.

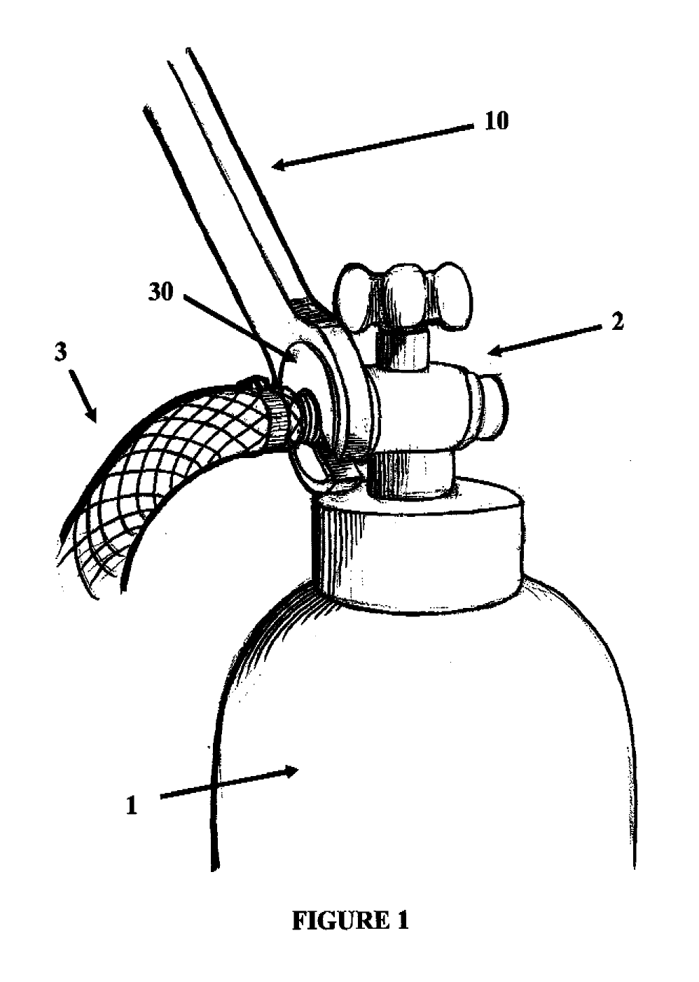

The head 12 of the spanner 10 includes a side edge opening 14 that extends from the distal side edge of the head to the internal aperture of the nut engaging portion 13. The side edge opening allows access to the internal aperture. The width of the opening 14 is dimensioned to be of a size that is only slightly greater than the width of a hose 3 (FIG. 1) connected to the hose coupling of the gas cylinder so that the spanner is when in use able to be positioned, via the side edge opening 14, on to the hose 3 (FIG. 1) and then slid along the hose until the internal face of the backing plate 30 abuts corresponding side face of the nut to indicate the correct positioning of the spanner 10 on the nut and then allow tightening or un-tightening the nut and when not in use be removed therefrom.

The backing plate 30 has an aperture 31 dimensioned less than the dimensions of the aperture of the nut engaging portion 13 but greater than the circumferential dimensions of a hose 3 (FIG. 1) connected to the hose coupling of the gas cylinder. The backing plate also has an opening of the same dimensions as the side edge opening 14 of the head 12 so that the spanner 10 is when in use able to be positioned, via the head side edge opening 14 and the backing plate opening, on to the hose 3 (FIG. 1) and then slid along the hose, via the internal aperture, to the nut until the internal face of the backing plate 30 abuts corresponding side face of the nut to indicate the correct positioning of the spanner 10 on the nut and then allow tightening or un-tightening the nut and when not in use be removed therefrom.

The longitudinal axis of the side edge opening 14 is co-axially aligned with the longitudinal axis of the spanner 10 such that the mouth of the opening extends outward and in a opposite direction to the handle 11.

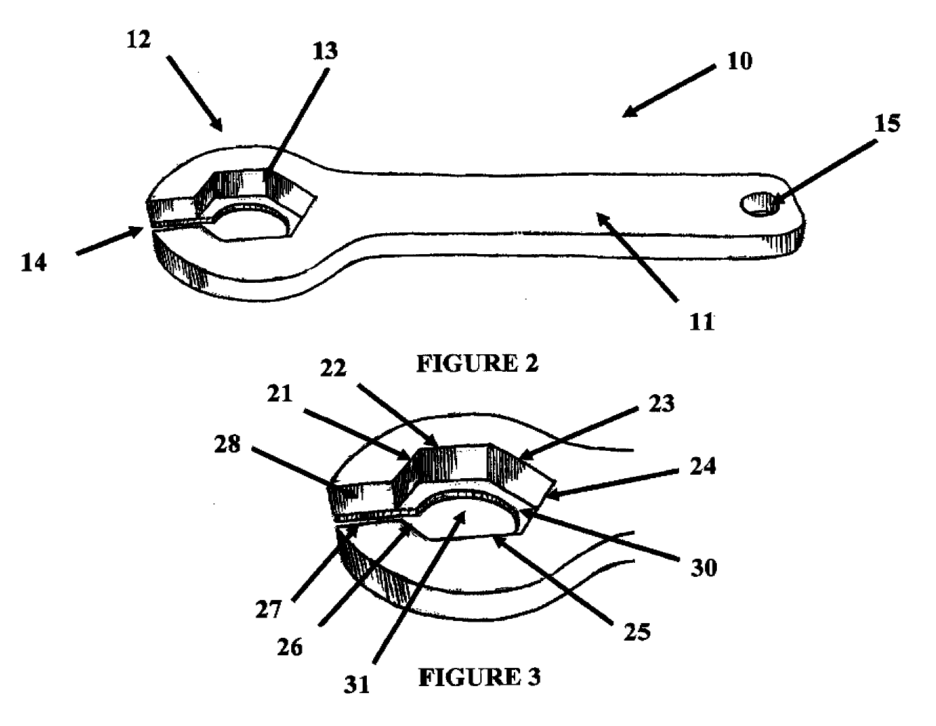

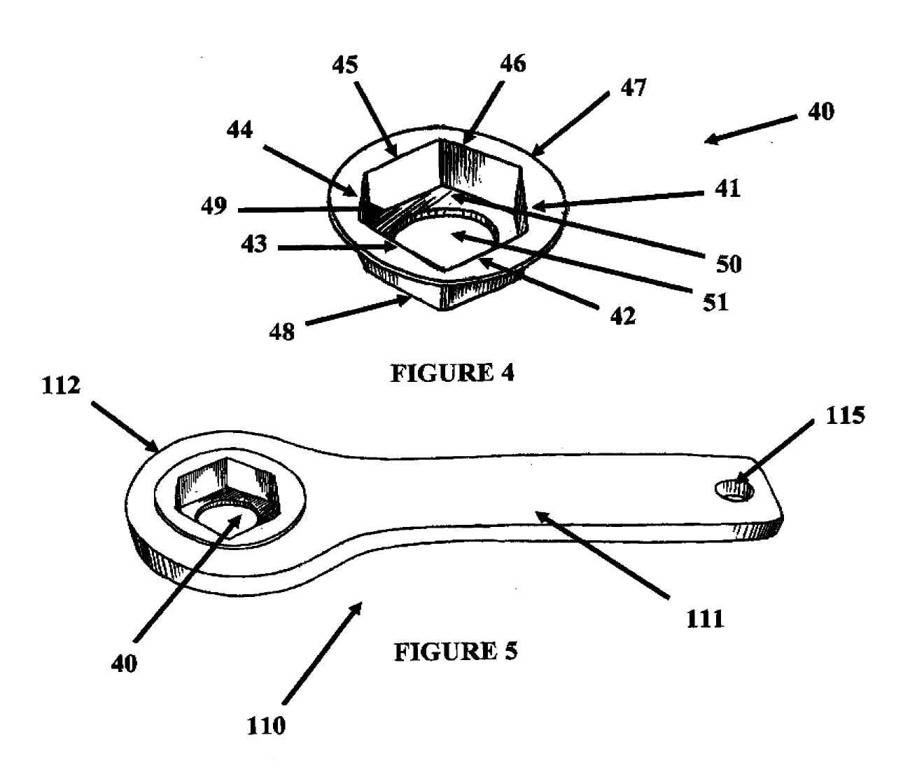

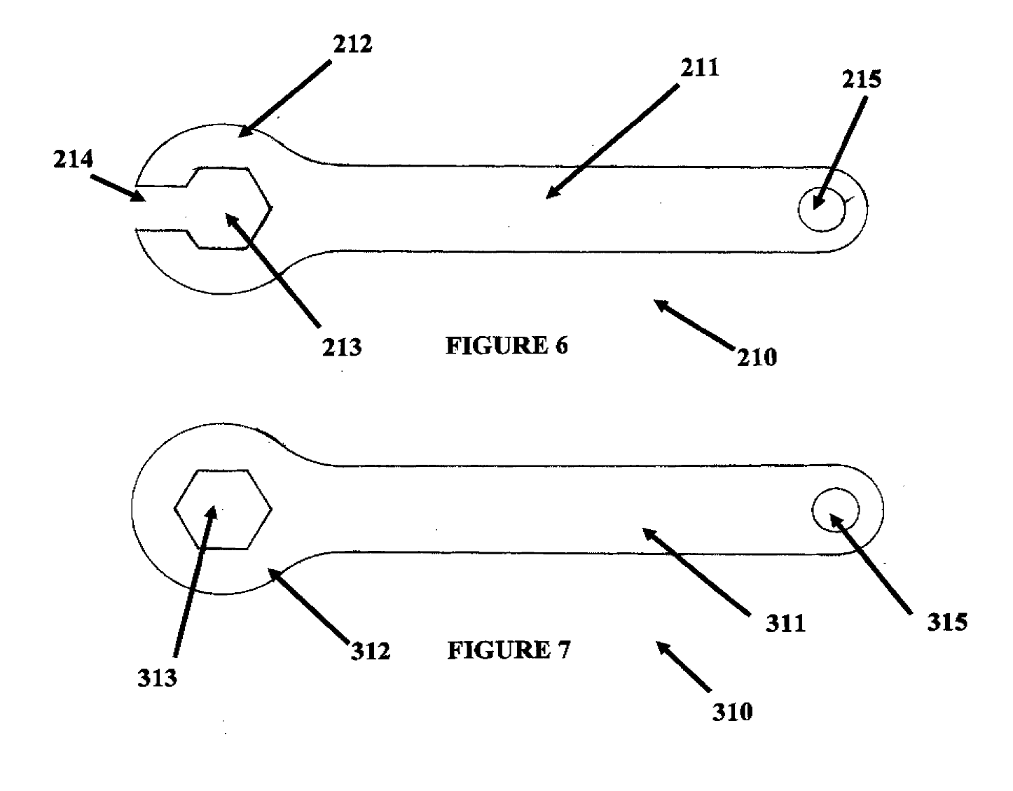

The spanner 10 as shown in FIGS. 2 and 3 due to inventive combined effects of the nut engaging portion 13 and the backing plate 30 prevents rotational and side slippage of the spanner 10 relative to the nut is prevented and prevents burring of the nut when tightening and un-tightening of the nut.

In operation when a hose 3 is to be connected or disconnected to the valve 2 of a gas cylinder 1, the spanner as shown in FIGS. 1 to 3 is used in the following manner. The spanner 10 cannot be situated directly on the nut due to the dimensions and configuration of the nut engaging portion 13 and that of the backing plate 30. The side edge opening 14 of the spanner is aligned with the hose just downstream from the nut and then slid forward so that the hose is positioned within the internal aperture of the nut engaging portion 13 and the corresponding aperture 31 in the backing plate 30. The side of the spanner 10 with the backing plate 30 is situated furthest away from the nut such that the open end of the nut engaging portion 13 immediately faces the nut. The spanner 10 is then moved toward the nut such the sides 21, 22, 23, 24, 25 & 26 of the nut engaging portion 13 are in full contact with corresponding side surfaces of the nut and the internal face of backing plate 30 contacts with side face of the nut that is distal from the valve. The spanner 10 is now in position to tighten or un-tighten the nut with out any side way or rotational slippage and without burring of the nut in the process. The spanner when not in use can be stowed away, for example in a tool box, until required again.

It is envisaged without departing from the scope of the invention, that the spanner can be retained on the hose when not in use. The spanner of this particular embodiment (not shown) has all the features of the spanner as shown in FIGS. 2 & 3 except it does not have the side edge opening in the head or the backing plate. The nut engaging portion is fully enclosed within the head of the spanner such that the spanner is able to be retained on the hose and slid along thereon to the nut when required and slid back there along when not required. In the first instance when the hose is fully discounted the spanner positioned on the hose by inserting the free end of the hose through the internal aperture of the nut engaging portion and then the hose is connected to the valve in the usual manner using the spanner to tighten the nut. When not in use the spanner is left to hang on the hose. This embodiment of the spanner allows for ready access to the spanner when changing cylinders.

The backing plate may have part of the opening that extends to and is flush with a side of the nut engaging portion such that when the spanner is not in use and is suspended from the hose, the portion of the hose in contact with the spanner rests on that side of the nut engaging portion, not on the edge of the backing plate in order to prevent the hose from being cut or damaged by the edges of the backing plate.

Turning to FIGS. 4 & 5 which describe a further embodiment of the invention involving inserts. The spanner 110 is similar to the spanner as shown in FIGS. 2 & 3 and has a handle 111 and a head 112 that has an aperture therethrough. The spanner 110 pertains to a spanner in which the aperture is fully enclosed within the head of the spanner, however it is envisaged that the head could also have a side edge opening similar to that shown in and described in reference to FIGS. 2 & 3. Preferably the aperture is also of the same hexagaonal dimensions and configuration as the internal aperture as shown and described with reference to FIGS. 2 & 3 and also the head of the spanner can have a backing plate. The aperture could also just be circular. The aperture is of a size to accommodate replaceable inserts 40. The inserts 40 can be of differing reducing sizes to accommodate differing nut sizes. Each insert has body 40 with a top edge portion 47 and depending bottom portion 48. The top edge portion 47 has a diameter that is greater than the diameter of the aperture in the head 112 in order to retain the insert in the aperture and to prevent the insert from falling through the aperture. The depending bottom portion 48 has a diameter the same or slightly less but substantially close thereto such that the insert 40 snugly and tightly fit and retained in the aperture. Also the aperture and has a depth sustainably equal to the depth of the aperture of the head.

The bottom portion 48 of the insert 40 has an internal wall that has six sides 41, 42, 43, 44, 45, 46 and that define an open ended internal aperture 49 that is dimensioned and configured to accommodate a corresponding sized hexagonal nut therein. The apertures open end of the insert opposite the open end adjacent the top edge portion includes a backing plate 50. The backing plate 50 has an aperture 51 that has a diameter less than the diameter of the internal aperture 49 but greater than the diameter of the gas cylinder hose such that the spanner 110 is able to be slid along the hose, via the internal aperture, to and from the nut.

The spanner 110 can includes a series of inserts 40 of varying reduced internal aperture diameter to allow the spanner 110 to be used with nuts of different sizes.

FIGS. 6 and 7 show two other versions of spanner that can be used with the insert 40. The spanner 210 (FIG. 6) has an internal aperture 213 in the head 212 in which an insert 40 of FIG. 4 can be used or a modified version that has a side opening that aligns with the side edge opening 214 of the spanner 210. The spanner 310 has a fully enclosed internal aperture 313 in the head 312 in which an insert 40 of FIG. 40 can be inserted therein.

The spanner can be made from any suitable rigid material, but preferably metal such as solid or cast steel (stainless or alloy). Also could be made from a suitable plastic/rubber material or a combination of metal and plastic/rubber. In respect of the inserts the spanner is preferably made from a plastic/rubber material and the insert made from metal such as solid or cast steel (stainless or alloy).

### ADVANTAGES

a) Reduced costs associated with not having to replace burred nuts
b) Reduced costs due to leakage of gas
c) Reduced gas leakage
d) Easy to use
e) No slippage when tightening or enlightening gas cylinder hose coupling nuts
f) No burring of the nut
g) Less likelihood of nut been over or under tightened.

### VARIATIONS

Throughout the description of this specification, the word “comprise” and variations of that word such as “comprising” and “comprises”, are not intended to exclude other additives, components, integers or steps.

It will of course be realised that while the foregoing has been given by way of illustrative example of this invention, all such and other modifications and variations thereto as would be apparent to persons skilled in the art are deemed to fall within the broad scope and ambit of claims appended to this specification.

What we claim is:

1: A non-slip and anti-burring spanner for tightening and un-tightening hose coupling nuts used with gas cylinder valves, said spanner includes:
(i) a body with a handle extending in one direction and a head extending in the opposite direction;
(ii) a nut engaging means positioned within the head, the nut engaging means defines an internal aperture having at least five nut engaging sides dimensioned and configured to snugly engage and co-operate with corresponding sides of a hexagonal nut used with gas cylinder hose couplings such that the sides of the nut engaging means have increased contact points with the sides of the nut in order to prevent slippage and burring; and
(iii) a backing plate attached to one side of the head and positioned over a part of the nut engaging means such that the backing plate is adapted to indicate the correct positioning of the spanner on the nut and to prevent side ways slippage of the spanner relative to said nut when tightening or un-tightening the nut;
wherein, when in use, the combination of the nut engaging means and the backing plate is such that rotational and side slippage of the spanner relative to the nut is prevented and burring of the nut is prevented when tightening and un-tightening of the nut.

2: The non-slip and anti-burring spanner as claimed in claim 1, wherein the nut engaging means has six nut engaging sides.

3: The non-slip and anti-burring spanner as claimed in claim 2, wherein the internal aperture is open to both sides of the head.

4: The non-slip and anti-burring spanner as claimed in claim 3, wherein the backing plate is positioned on the head such that the backing plate covers one of the openings of the aperture defined by the nut engaging means.

5: The non-slip and anti-burring spanner as claimed in claim 4, wherein the backing plate has an internal aperture dimensioned less than the dimensions of the aperture of the nut engaging means but greater than the circumferential dimensions of a hose connected to the hose coupling of the gas cylinder such that the spanner is adapted to be retained on the hose when not in use and when in use adapted to be slid along the hose, via the apertures of the backing plate and the nut engaging means, to the nut so as to allow tightening or un-tightening the nut.

6: The non-slip and anti-burring spanner as claimed in claim 5, wherein the head of the spanner includes a side edge opening that extends from the distal side edge of the head to the internal aperture of the nut engaging means to allow access to the internal aperture of the nut engaging means, wherein the width of the opening is dimensioned to be of a size that is only slightly greater than the width of a hose connected to the hose coupling of the gas cylinder such that the spanner is adapted when in use to be positioned, via the side edge opening, on to the hose and then slid along the hose, via the internal aperture of the nut engaging means, to the nut so as to allow tightening or un-tightening the nut and when not in use be removed therefrom.

7: The non-slip and anti-burring spanner as claimed in claim 6, wherein the longitudinal axis of the side edge opening is co-axially aligned with the longitudinal axis of the spanner such that the mouth of the side edge opening extends outward and in an opposite direction to the handle.

8: The non-slip and anti-burring spanner as claimed in claim 7, wherein the backing plate has an internal aperture dimensioned less than the dimensions of the internal aperture of the nut engaging means but greater than the circumferential dimensions of a hose connected to the hose coupling of the gas cylinder and has an opening of the same dimensions as the side edge opening of the head such that the spanner is adapted when in use to be positioned, via the head side edge opening and the backing plate opening, on to the hose and then slid along the hose, via the internal apertures, to the nut so as to allow tightening or un-tightening the nut and when not in use be removed therefrom.

9: The non-slip and anti-burring spanner as claimed in claim 8, wherein the spanner includes a hollow insert that is adapted to fit within the internal aperture defined by the nut engaging means, the internal walls of the insert are dimensioned and configured to have at least five sides and are adapted to cooperate with the hexagonal sides of the nut such that, the insert is adapted to allow for nuts of reduced size.

10: The non-slip and anti-burring spanner as claimed in claim 9, wherein the spanner is useable with a series of inserts each of varying reduced dimensions to allow the spanner to be used with nuts of different sizes.

11: The non-slip and anti-burring spanner as claimed in claim 10, wherein the insert has two open ends, one of which is covered with an insert backing plate that has an aperture dimensioned less than the dimensions of the inserts aperture, but greater than the circumferential dimensions of the hose.

12: The non-slip and anti-burring spanner as claimed in claim 11, wherein each insert includes a side edge opening that cooperates and aligns with the corresponding side edge opening in the head of the spanner and includes a similar dimensioned positioned opening in the insert backing plate, such that the spanner is adapted when in use to be positioned, via the respective side edge openings and the backing plate opening, on to the hose and then slid along the hose, via the inserts aperture, to the nut so as to allow tightening or un-tightening the nut and when not in use be removed therefrom.
